(19) United States
(12) Patent Application Publication
(10) Pub. No.: US 2024/0278317 A1
(43) Pub. Date: Aug. 22, 2024

(54) PERMANENT MAGNET POWDER MANUFACTURED BY REDUCTION-DIFFUSION METHOD, CLEANING DEVICE AND CLEANING METHOD FOR CLEANING THE SAME

(71) Applicants: Hyundai Motor Company, Seoul (KR); Kia Corporation, Seoul (KR)

(72) Inventors: Bo Kyeong Han, Hwaseong (KR); Yong-Ho Choa, Seongnam (KR); Saemee Yun, Hwaseong (KR); Jimin Lee, Ansan (KR); Byungkwon Jang, Pyeongtaek (KR)

(21) Appl. No.: 18/626,129

(22) Filed: Apr. 3, 2024

Related U.S. Application Data
(62) Division of application No. 18/075,741, filed on Dec. 6, 2022.

(30) Foreign Application Priority Data
Jun. 29, 2022 (KR) 10-2022-0079932

(51) Int. Cl. B22F 1/142; B08B 3/08; B08B 3/10; B08B 13/00; B22F 9/04; C01G 49/00; H01F 1/057

(52) U.S. Cl. CPC B22F 1/142; B08B 3/08; B08B 3/102; B08B 13/00; B22F 9/04; C01G 49/009; H01F 1/057; H01F 1/0573; B22F 2201/20

(57) ABSTRACT

Provided is a cleaning device for cleaning a magnet powder including: a flask provided to contain the magnet powder and a cleaning material used to clean the magnet powder; and a vacuum manifold provided to maintain the magnet powder and the cleaning material contained in the flask in an inert state during cleaning.

Provided is a method for cleaning a magnet powder including a loading operation for loading a magnet powder, a cleaning solution, and zeolite into a flask; a gas injecting operation for injecting an inert gas into the flask; and a vacuum drying operation for drying the magnet powder and the zeolite in a vacuum.

Provided is a method for manufacturing a magnet powder including: preparing a primary mixture by mixing neodymium (III) nitrate, boric acid, and iron (III) nitrate nonahydrate; preparing an oxide by heat-treating the primary mixture; removing a residual organic material of the oxide by heat-treating the oxide; preparing a hydrogen-reduced oxide by reacting the oxide, from which the residual organic material is removed, with hydrogen by heat treatment; preparing a secondary mixture by mixing the hydrogen-reduced oxide with calcium; obtaining a product by subjecting the secondary mixture to reduction-diffusion reaction by heat treatment; and obtaining Nd₂Fe₁₄B powder by pulverizing the product.

### CROSS-REFERENCE TO RELATED APPLICATION

This application is based on and claims priority under 35 U.S.C. § 119 to Korean Patent Application No. 10-2022-0079932, filed on Jun. 29, 2022, in the Korean Intellectual Property Office, the disclosure of which is incorporated herein by reference.

### TECHNICAL FIELD

The present disclosure relates to a permanent magnet powder manufactured by a reduction-diffusion method, and a cleaning device and a cleaning method for cleaning the same.

### BACKGROUND

In accordance with the needs for eco-friendly businesses, the demand for high-efficiency permanent magnet motors has been rapidly growing to satisfy requirements in the hybrid and electric automotive industry such as compactness, lightweight, and high efficiency of products.

As a main component of common permanent magnet motors, Nd₂Fe₁₄B that is a compound of a rare-earth element neodymium (Nd), iron (Fe), and boron (B) having the strongest magnetic properties among existing magnets has been used.

Conventional methods for manufacturing Nd₂Fe₁₄B are based on top-down approaches. However, there may be problems of difficulty in controlling grain size and microstructure of manufactured magnetic material and difficulty in controlling chemical composition thereof causing adverse effects on properties of Nd-based magnets.

Therefore, bottom-up approaches based on chemical reaction at the molecular level have drawn attention. Such methods are used to manufacture magnet powder (oxide) by a calcium reduction-diffusion method. In general, after conducting a reduction-diffusion reaction using Ca and CaH₂ as reducing agents, a cleaning process is performed to remove calcium impurities to obtain high-purity magnetic powder.

As cleaning solutions, ultrapure water, dilute acid, and a mixture of ultrapure water and alcohol have been known. However, in the case of using those cleaning solutions, calcium impurities may remain after the cleaning process or introduction of secondary impurities or damage to magnet powder caused by side reactions have been reported.

According to the related art to solve the problems, magnet powder has been cleaned using a polar non-aqueous organic solvent in which a soluble salt is dissolved, a non-aqueous fatty acid, and a hydrocarbon-based organic solvent. However, because even a non-aqueous organic solvent contains water, a magnetic material may be hydrated during cleaning.

### SUMMARY

Provided are a method for manufacturing a magnet powder using a calcium reduction-diffusion method, a cleaning device for completely removing moisture to prevent hydrogenation of a magnetic material during cleaning without causing side reaction, and a cleaning method therefor.

However, the technical problems to be solved by the present disclosure are not limited to the aforementioned problems, and any other technical problems not mentioned herein will be clearly understood from the following description by those skilled in the art to which the present disclosure pertains.

In an aspect, provided is a cleaning device for cleaning a magnet powder includes: a flask provided to contain the magnet powder and a cleaning material used to clean the magnet powder; and a vacuum manifold provided to maintain the magnet powder and the cleaning material contained in the flask in an inert state during cleaning.

The term “vacuum manifold” as used herein refers to a chemistry apparatus consists of dual manifolds (e.g., one connected to a source of an inert gas and the other connected to a vacuum pump) with several ports.

The cleaning device may further include: a gas inlet provided to inject an inert gas; a vacuum pump provided to remove gas contained in the flask; and a cold trap provided to condense the gas sucked into the vacuum pump.

The cleaning device may further include an oil bubbler provided to discharge the inert gas.

The magnet powder may include Nd₂Fe₁₄B powder manufactured by a calcium reduction-diffusion method.

The cleaning material may include a cleaning solution including NH₄NO₃ and methanol, and zeolite.

A molarity of the cleaning solution including NH₄NO₃ and methanol may be from about 0.05 M to about 0.2 M.

In another aspect, provided is a method for cleaning a magnet powder includes: loading a magnet powder, a cleaning solution, and zeolite into a flask; injecting an inert gas into the flask; and drying the magnet powder and the zeolite in a vacuum.

The method may further include: manufacturing the magnet powder loaded into the flask; and preparing the cleaning solution including an ammonium salt and methanol.

The magnet powder may include Nd₂Fe₁₄B powder manufactured by a calcium reduction-diffusion method.

The ammonium salt may be NH₄NO₃, and a molarity of NH₄NO₃ and methanol of the cleaning solution may be from about 0.05 M to about 0.2 M.

The loading operation, the gas injecting operation, and the vacuum drying operation may be repeated three times to five times.

The method may include using a cleaning device, wherein the cleaning device includes a vacuum manifold provided to maintain the magnet powder, the cleaning solution, and the zeolite contained in the flask in an inert state.

The cleaning device may further include: a gas inlet provided to inject an inert gas; a vacuum pump provided to remove gas contained in the flask; and a cold trap provided to condense the gas sucked into the vacuum pump.

The cleaning device may further include an oil bubbler provided to discharge the inert gas.

In an aspect, provided is a method for manufacturing a magnet powder includes: preparing a primary mixture including neodymium (III) nitrate, boric acid, and iron (III) nitrate nonahydrate; preparing an oxide by heat-treating the primary mixture at a first temperature; removing a residual organic material of the oxide by heat-treating the oxide at a second temperature; preparing a hydrogen-reduced oxide by heat-treating the oxide, from which the residual organic material is removed, with hydrogen at a third temperature; preparing a secondary mixture including the hydrogen-reduced oxide with calcium; obtaining a product by heat-treating the secondary mixture at a fourth temperature for reduction-diffusion; and obtaining Nd₂Fe₁₄B powder by pulverizing the product.

The first heat treatment temperature may be from about 200 to about 400° C.

The heat treating the oxide may be performed at the second temperature of about 600 to 800° C. for about 150 to 200 minutes.

The heat treating the oxide, from which the residual organic material is removed, with hydrogen may be performed at the third temperature of about 700 to 900° C. for about 100 to 150 minutes.

The heat treating the secondary mixture to reduction-diffusion reaction may be performed at the fourth temperature of about 750 to 900° C. for about 150 to 200 minutes.

Other aspects are disclosed infra.

### BRIEF DESCRIPTION OF DRAWINGS

The patent or application file contains at least one drawing executed in color. Copies of this patent or patent application publication with color drawing(s) will be provided by the Office upon request and payment of the necessary fee.

FIG. 1 shows an exemplary cleaning device in a cleaning operation according to an exemplary embodiment of the present disclosure.

FIG. 2 shows an exemplary cleaning device in a vacuum drying operation according to an exemplary embodiment of the present disclosure.

FIG. 3 shows an exemplary cleaning method according to an exemplary embodiment of the present disclosure.

FIG. 4 shows an exemplary powder manufacturing operation and an exemplary cleaning solution preparing operation added to the cleaning method according to an exemplary embodiment of the present disclosure.

FIG. 5 shows photographs for comparison of degrees of side reaction according to exemplary cleaning solutions.

FIG. 6 shows an exemplary powder obtaining operation according to an exemplary embodiment of the present disclosure.

FIG. 7 shows an exemplary method for manufacturing magnet powder according to an exemplary embodiment of the present disclosure.

FIG. 8 shows XRD pattern analysis of Example 1 and Comparative Example 1.

FIG. 9 shows a VSM graph of Example 1 and Comparative Example 1.

FIG. 10 shows a VSM graph of Example 2 and Comparative Example 2.

FIG. 11 shows a graph illustrating XRD pattern analysis of Example 2 and Comparative Example 1.

FIG. 12 shows a VSM graph of Example 2 and Comparative Example 1.

### DETAILED DESCRIPTION

Hereinafter, embodiments of the present disclosure will be described. The invention may, however, be embodied in many different forms and should not be construed as being limited to the embodiments set forth herein. Rather, these embodiments are provided so that this disclosure will be thorough and complete, and will fully convey the concept of the invention to those skilled in the art.

All terms used throughout the specification are merely used to describe particular embodiments, and are not intended to limit the present disclosure. An expression used in the singular encompasses the expression of the plural unless it has a clearly different meaning in the context. In addition, it is to be understood that the terms such as “comprising”, “including” or “having”, etc. used herein are intended to indicate the existence of the features, operations, functions, components, or combinations thereof disclosed in the specification, and are not intended to preclude the possibility that one or more other features, operations, functions, components, or combinations thereof may exist or may be added.

Meanwhile, unless otherwise defined, all terms used herein have the same meaning as commonly understood by one of ordinary skill in the art to which this disclosure belongs. Thus, these terms should not be interpreted in an idealized or overly formal sense unless expressly so defined herein. As used herein, the singular forms are intended to include the plural forms as well, unless the context clearly indicates otherwise.

The terms “about”, “substantially”, etc. used throughout the specification means that when a natural manufacturing and a substance allowable error are suggested, such an allowable error corresponds the value or is similar to the value, and such values are intended for the sake of clear understanding of the present disclosure or to prevent an unconscious infringer from illegally using the disclosure of the present disclosure. Further, unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.” The embodiments described in the specification and shown in the drawings are only illustrative and are not intended to represent all aspects of the invention, such that various modifications may be made without departing from the spirit of the invention.

In the present specification, when a range is described for a variable, it will be understood that the variable includes all values including the end points described within the stated range. For example, the range of “5 to 10” will be understood to include any subranges, such as 6 to 10, 7 to 10, 6 to 9, 7 to 9, and the like, as well as individual values of 5, 6, 7, 8, 9 and 10, and will also be understood to include any value between valid integers within the stated range, such as 5.5, 6.5, 7.5, 5.5 to 8.5, 6.5 to 9, and the like. Also, for example, the range of “10% to 30%” will be understood to include subranges, such as 10% to 15%, 12% to 18%, 20% to 30%, etc., as well as all integers including values of 10%, 11%, 12%, 13% and the like up to 30%, and will also be understood to include any value between valid integers within the stated range, such as 10.5%, 15.5%, 25.5%, and the like.

In addition, in the drawings of the present disclosure, like reference numerals will be assigned to like parts or components having substantially same functions.

In addition, the terms used in the specification are merely used to describe particular embodiments, and are not intended to limit the present disclosure. An expression used in the singular encompasses the expression of the plural unless it has a clearly different meaning in the context.

In addition, and the operations may be performed in a different order unless the order of operations are clearly stated.

Hereinafter, a cleaning device 100 for cleaning magnet powder according to an embodiment will be described in detail.

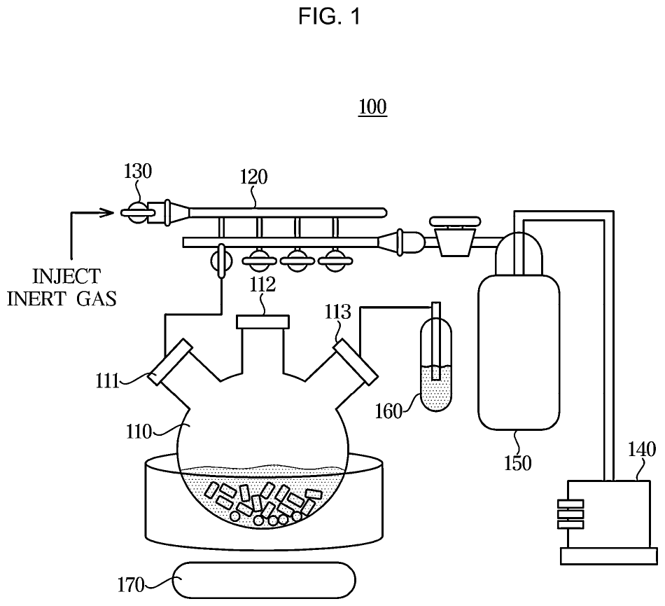

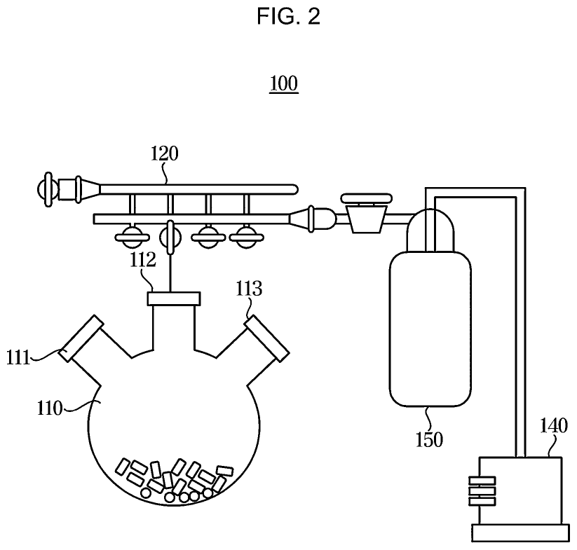

FIG. 1 shows an exemplary cleaning device 100 in a cleaning operation according to an exemplary embodiment. FIG. 2 shows an exemplary cleaning device 100 in a vacuum drying operation according to an exemplary embodiment.

The cleaning device 100 for cleaning magnet powder according to an exemplary embodiment includes a flask 110 provided to contain magnet powder and a cleaning material used to clean the magnet powder; and a vacuum manifold 120 provided to maintain the magnet powder and the cleaning material contained in the flask 110 in an inert state during cleaning. Exemplary vacuum manifold may include a Schlenk line.

The flask 110 may be a 3-neck round-bottom flask including a first neck 111, a second neck 112, and a third neck 113. Pulverized magnet powder and the cleaning material may be contained in the flask 110. By using the Schlenk line 120 connected to the 3 necks, cleaning may be conducted using one flask 110 without moving the magnet powder and the cleaning material, and the magnet powder and the cleaning material are prevented from being in contact with air during a cleaning process.

Because the vacuum manifold 120 may maintain the atmosphere inside the flask 110 in an inert state during cleaning and may be used for vacuum drying of the magnet powder and zeolite, the magnet powder and the cleaning material may be prevented from being in contact with air throughout the cleaning operation.

In the case of using the vacuum manifold 120 in the cleaning device, external air is blocked throughout the cleaning operation 1100, corresponding to a loading operation 1110 of the cleaning solution, a gas injecting operation 1120, and a vacuum drying operation 1130, so that by-products of the magnet powder may be selectively removed. In addition, damage to the magnet powder may be minimized and purity of the magnet powder may be increased.

The cleaning device 100 for cleaning magnet powder according to an embodiment may further include a gas inlet 130 to inject an inert gas; a vacuum pump 140 provided to suck gas contained in the flask 110; and a cold trap 150 to condense the gas sucked into the vacuum pump 140.

The gas inlet 130 for injecting the inert gas and the vacuum pump 140 for removing the gas contained in the flask 110 may be connected to the vacuum manifold 120.

The gas injected into the gas inlet 130 may be an inert gas such as Ar or N₂. The inert gas to be injected into the gas inlet 130 may be injected through the first neck 111, the second neck 112, or the third neck 113 via the vacuum manifold 120.

The vacuum pump 140 may suck gas remaining in the flask 110 after cleaning. The gas being sucked may include air present in the flask 110, a gas vaporized from the cleaning solution, and the like. Also, the cleaning solution may also be sucked in a liquid state without being vaporized in the process being sucked into the vacuum pump 140.

By using the vacuum pump 140, powder may be dried without being moved to a vacuum oven. In the case of using the vacuum pump 140, the vacuum manifold 120 may be connected to a neck different from the neck through which the inert gas is inserted into the flask 110. When drying is performed using the vacuum pump 140, the gas contained in the flask 110 may be sucked into the vacuum pump 140 through the vacuum manifold 120 connected to a neck different from the neck through which the inert gas is injected into the flask 110.

For example, in the case where the first neck 111 of the flask 110 connected to the vacuum manifold 120 is used to inject the inert gas, the vacuum manifold 120 connected to the vacuum pump 140 may be connected to the second neck 112 or the third neck 113 of the flask 110.

Because steam or a solution entering the vacuum pump 140 may cause malfunction, the cold trap 150 may be disposed between the vacuum manifold 120 and the vacuum pump 140. The cold trap 150 sucks inert gas remaining in the flask 110, existing air, and a gas vaporized from the cleaning solution. The cleaning solution in a liquid state without being vaporized may also be sucked.

Before the gas or the liquid enters the vacuum pump 140, the cold trap 150 may condense the gas into a liquid to prevent the gas or the liquid from entering the vacuum pump 140.

The cleaning device 100 for cleaning magnet powder according to an exemplary embodiment may further include an oil bubbler 160 provided to discharge the inert gas.

The oil bubbler 160 may be connected to a neck different from the neck through which the inert gas is injected into the flask 110 and the neck connected to the vacuum pump 140. Alternatively, the oil bubbler 160 may be connected to the opposite side of the vacuum manifold 120 to the gas inlet 130.

In the case where the oil bubbler 160 is connected to the neck different from the neck through which the inert gas is injected into the cleaning device 100 and the neck connected to the vacuum pump 140, rather than the opposite side to the gas inlet 130, the oil bubbler 160 may serve to check injection of the inert gas while injecting the inert gas or measure an injected degree. Alternatively, the oil bubbler 160 may be connected to discharge the inert gas.

For example, in the case where the first neck 111 of the flask 110 is connected to the vacuum manifold 120 to inject the inert gas and the second neck 112 of the flask 110 is connected to the vacuum manifold 120 for connection with the vacuum pump 140, the oil bubbler 160 may be connected to the third neck 113.

The cleaning device 100 may include a stirrer 170 for temperature and speed control to control a temperature inside the flask 110 or to physically separate calcium and a magnetic material by circulating the magnet powder and the cleaning material. The temperature and speed of the stirrer 170 may be arbitrarily selected. A preferred speed may be from about 100 to about 1000 rpm.

The magnet powder contained in the flask 110 may include Nd₂Fe₁₄B powder manufactured by a calcium reduction-diffusion method. In addition, the cleaning material contained therein may include a cleaning solution and zeolite, and the cleaning solution may include NH₄NO₃ and methanol. In addition, a molarity of the cleaning solution including NH₄NO₃ and methanol may be from about 0.05 M to about 0.2 M. Preferably, the molarity may be about 0.1 M.

In the case of cleaning using the cleaning device 100 according to an exemplary embodiment, oxidation of the magnet powder may be prevented by keeping the magnet powder from being in contact with air throughout the cleaning process. Also, when the cleaning is performed using the cleaning device 100 according to an exemplary embodiment, by-products may be selectively removed by maintaining the entire cleaning process in an inert environment, damage to the magnet powder may be minimized, and purity of powder may be improved.

Hereinafter, a method for cleaning magnet powder 1100 according to an embodiment will be described in detail.

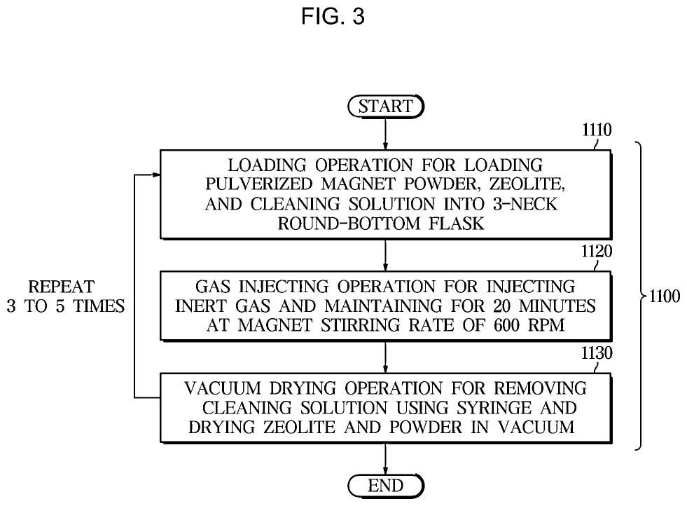

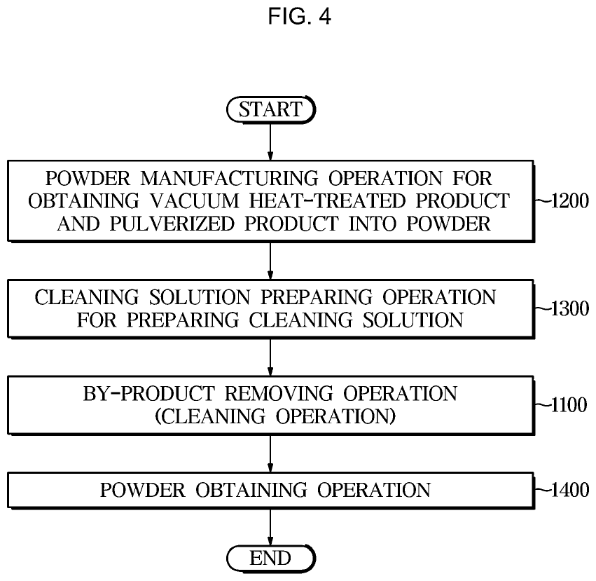

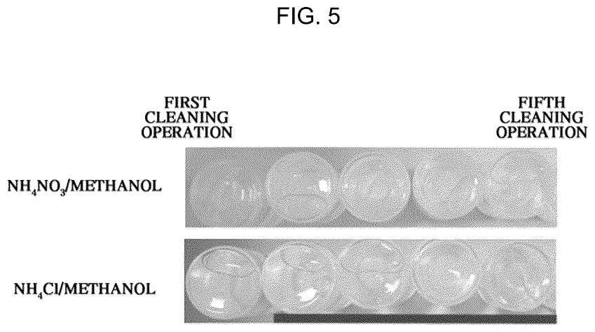

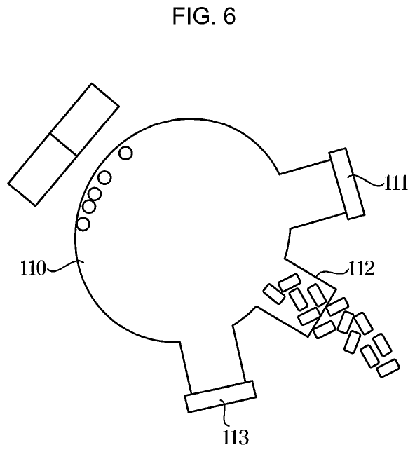

FIG. 3 shows an exemplary cleaning method 1100 according to an exemplary embodiment. FIG. 4 is a flowchart of a powder manufacturing operation 1200 and a cleaning solution preparing operation 1300 added to the cleaning method 1100 according to an exemplary embodiment. FIG. 5 shows photographs for comparison of degrees of side reaction according to cleaning solutions. FIG. 6 is a powder obtaining operation 1400 according to an exemplary embodiment.

The method for cleaning magnet powder 1100 according to an exemplary embodiment includes: a loading operation 1110 for loading magnet powder, a cleaning solution, and zeolite into a flask; a gas injecting operation 1120 for injecting an inert gas into the flask; and a vacuum drying operation 1130 for drying the magnet powder and the zeolite in a vacuum.

The cleaning method 1100 for cleaning magnet powder according to an exemplary embodiment may further include a powder manufacturing operation 1200 for manufacturing the magnet powder loaded into the flask; and a cleaning solution preparing operation 1300 for preparing the cleaning solution by mixing an ammonium salt with methanol.

The magnet powder manufactured in the powder manufacturing operation 1200 according to an exemplary embodiment may include Nd₂Fe₁₄B powder manufactured by a calcium reduction-diffusion method. The manufactured magnet powder may be loaded into the flask in the loading operation 1110.

The cleaning solution prepared in the cleaning solution preparing operation 1300 according to an exemplary embodiment may include an ammonium salt and methanol. In addition, the ammonium salt included in the cleaning solution may be NH₄NO₃. In addition, a molarity of NH₄NO₃ and methanol of the cleaning solution may be from about 0.05 M to about 0.2 M. Preferably, the molarity may be about 0.1 M. The cleaning solution may be loaded into the flask in the cleaning solution loading operation 1110.

As shown in FIG. 5, a degree of side reaction in the case of using NH₄NO₃ as the cleaning solution according to an exemplary embodiment may be compared with a degree of side reaction in the case of using NH₄Cl. When NH₄NO₃ is used as the ammonium salt of the cleaning solution, the degree of side reaction in a solution obtained after cleaning may be lower than that obtained using NH₄Cl. In addition, a degree of a color such as pale yellow obtained by the side reaction may be low.

In the case where the cleaning solution includes NH₄NO₃ and methanol, the cleaning solution reacts with a by-product CaO during the cleaning operation 1100 of the magnet powder to generate NH₄OH. The generated NH₄OH may be decomposed into NH₃ and H₂O. Also, NH₄OH may react with a by-product Ca to generate H₂.

As shown in FIG. 4, a by-product removing operation corresponds to the cleaning operation 1100, and referring to FIG. 3, the cleaning operation 1100 may include the loading operation 1110, the gas injecting operation 1120, and the vacuum drying operation 1130.

In order to prevent side reaction of the magnet powder with H₂O and H₂ generated during the cleaning operation 1100, H₂O dissolved in methanol, and H₂O in the air, the cleaning material may include zeolite in the loading operation 1110. An amount of zeolite contained therein may be from about 5 to about 60 g, and zeolite 3 Å may be used.

When the cleaning material includes zeolite, H₂O and H₂ generated during cleaning, H₂O dissolved in methanol, and H₂O in the air may be adsorbed thereto. Accordingly, the by-products of the magnet powder may be effectively removed. As hydrogenation is reduced while cleaning the magnet powder, side reaction of the magnet powder may be minimized.

Also, when the cleaning material includes zeolite, zeolite is an environmentally friendly material reusable by heat treatment at a temperature of about 200 to 220° C., and costs of the cleaning operation 1100 may be reduced.

By the gas injecting operation 1120, the inside of the flask may be maintained in an inert state by injecting an inert gas thereinto. The magnet powder, zeolite, and the cleaning solution may be kept in an inert state not to be in contact with the air throughout the cleaning process.

The vacuum drying operation 1130 may be a process of removing the cleaning solution and drying the magnet powder and zeolite in a vacuum. Also, a syringe may be used to remove the cleaning solution.

The cleaning operation 1100 may be repeated three times to five times. Also, the cleaning operation 1100 may be conducted for about 20 minutes. After the magnet powder, zeolite, and the cleaning solution are added in the first loading operation 1110, the following cleaning operations 1100 may be repeated using new zeolite and a new cleaning solution. In the last cleaning operation 1100, pure methanol may be used as the cleaning solution instead of the mixture of NH₄NO₃ and methanol. Also, the pure methanol in the same amount as that used in the previous cleaning operation 1100 may be used. In addition, a residual by-product removed thereby may be Ca(NO₃)₂, or the like.

As shown in FIG. 6, after the vacuum drying operation 1130, the powder obtaining operation 1400 may be performed to obtain magnet powder by separating the magnet powder from zeolite using a permanent magnet. Because the magnet powder is a magnetic material, and zeolite is a non-magnetic material, the magnet powder may be separated using about 0.1 T permanent magnet. Also, via the permanent magnet, the magnet powder may be separated from zeolite to obtain the magnet powder.

In the case of cleaning using the cleaning method 1100 according to an embodiment, side reaction of the magnet powder may be minimized by adsorbing H₂O and H₂ onto zeolite included in the cleaning material during the cleaning process. Hydrogenation of the magnet powder may be prevented thereby.

The cleaning operation 1100, as the cleaning method according to an exemplary embodiment, may be performed using the cleaning device 100 according to an exemplary embodiment of the present disclosure. A case of using the cleaning device 100 according to an exemplary embodiment in the loading operation 1110 and the gas injecting operation 1120 is shown in FIG. 1, and a case of using the cleaning device 100 according to an exemplary embodiment in the vacuum drying operation 1130 is shown in FIG. 2.

In the case of conducting the loading operation 1110 and the gas injecting operation 1120 using the cleaning device 100 according to an exemplary embodiment of the present disclosure, side reaction may be prevented during the cleaning process by maintaining the magnet powder, the cleaning solution, and zeolite in an inert state.

In the case of conducting the vacuum drying operation 1130 using the cleaning device 100 according to an embodiment of the present disclosure, a vacuum may be directly applied to the magnet powder and zeolite contained in the flask 110 by using the vacuum manifold 120, and thus a stronger vacuum may be applied to the magnet powder compared to that used in the case of drying in a vacuum oven, thereby enabling the drying without controlling temperature.

In the case of performing the cleaning method 1100 according to an exemplary embodiment using the cleaning device 100 according to an exemplary embodiment, the by-product may be selectively removed, damage to the magnet powder may be minimized, and purity of the powder may be improved by maintaining the inside of the cleaning device 100 in an inert environment by blocking the inside from external air throughout the cleaning process.

The flask 110, the vacuum manifold 120, the gas inlet 130, the vacuum pump 140, the cold trap 150, the oil bubbler 160, and the stirrer 170 are as described above with reference to the cleaning device 100 according to an exemplary embodiment of the present disclosure. Also, the order of the loading operation 1110, the gas injecting operation 1120, and the vacuum drying operation 1130 of the cleaning operation 1100 is not limited to that shown in the flowchart of FIG. 3, and these operations may also be performed simultaneously or sequentially. The order of the powder manufacturing operation 1200, the cleaning solution preparing operation 1300, the cleaning operation 1100, and the powder obtaining operation 1400 is not limited to that shown in the flowchart of FIG. 4, and these operations may also be performed simultaneously or sequentially. In addition, the number of repetition and time may vary if required.

Hereinafter, a method for manufacturing magnet powder (2000) according to an exemplary embodiment of the present disclosure will be described in detail.

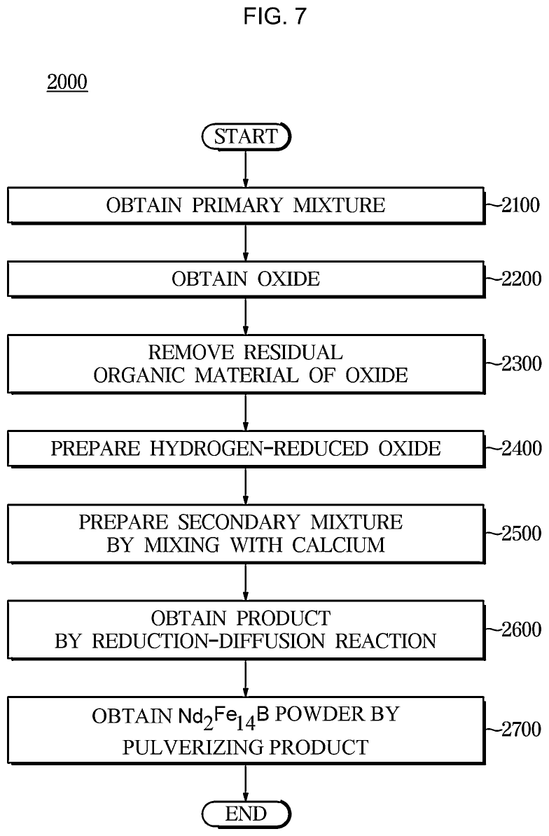

FIG. 7 shows an exemplary method for manufacturing magnet powder according to an embodiment (2000).

The method for manufacturing magnet powder according to an embodiment (2000) may include: preparing a primary mixture including neodymium (III) nitrate, boric acid, and iron (III) nitrate nonahydrate (2100); preparing an oxide by heat-treating the primary mixture (2200) at a first temperature; removing a residual organic material of the oxide by heat-treating the oxide (2300) at a second temperature; preparing a hydrogen-reduced oxide by reacting the oxide, from which the residual organic material is removed, with hydrogen by heat treatment (2400) at a third temperature; preparing a secondary mixture including the hydrogen-reduced oxide and calcium (2500); obtaining a product by subjecting the secondary mixture to reduction-diffusion reaction by heat treatment (2600) at a fourth temperature; and obtaining Nd₂Fe₁₄B powder by pulverizing the product (2700).

In the method for manufacturing the magnet powder, a heat treatment temperature of the preparing of the oxide (2200) may be from about 200 to 400° C. (the first temperature). Preferably, the heat treatment temperature may be about 300° C.

In the method for manufacturing the magnet powder, the heat treatment of the removing of the residual organic material of the oxide (2300) may be performed at a temperature of about 600 to 800° C. (the second temperature) for about 150 to 200 minutes. Preferably, the heat treatment may be performed at about 700° C. for about 180 minutes.

The removing of the residual organic material (2300) may be performed under atmospheric conditions. Alternatively, this process may be performed in a box furnace.

In the method for manufacturing the magnet powder, the heat treatment of the preparing of the hydrogen-reduced oxide (2400) may be performed at a temperature of about 700 to 900° C. (the third temperature) for 100 to 150 minutes. Preferably, this process may be performed at about 800° C. for 120 minutes.

The preparing of the hydrogen-reduced oxide (2400) may be performed in a about 5% H₂/Ar atmosphere. Also, this process may be performed in a tube furnace.

The preparing of the second mixture by mixing the hydrogen-reduced oxide with calcium (2500) may include a process of applying a pressure to the second mixture using a mold. By applying the pressure, the secondary mixture may be pelletized.

The mold may have a circular shape, and a model made by applying a pressure may be a circular model having a diameter Φ of about 20 mm. In addition, the pressure may be about 10 MPa or greater, preferably, about 20 MPa.

In the method for manufacturing the magnet powder, the heat treatment of the obtaining of the product by subjecting the secondary mixture to reduction-diffusion reaction (2600) may be performed at a temperature of about 750 to 900° C. (the fourth temperature) for 150 to 200 minutes. Preferably this process may be performed at about 850° C. for about 180 minutes.

The obtaining of the product by reduction-diffusion reaction of the secondary mixture (2600) may be performed in an inert gas atmosphere. The inert gas may be Ar or N₂. Also, this process may be performed in a tube furnace.

In the obtaining of Nd₂Fe₁₄B powder by pulverizing the product (2700), the powder may be obtained by pulverizing the product.

In order to remove a calcium-reduced by-product of Nd₂Fe₁₄B obtained according to the method for manufacturing magnet powder according to the present disclosure (2000), the powder may be cleaned using the cleaning method 1100 according to an exemplary embodiment of the present disclosure.

In order to remove the calcium-reduced by-product of Nd₂Fe₁₄B obtained according to the method for manufacturing magnet powder according to an exemplary embodiment of the present disclosure (2000), the powder may be cleaned using the cleaning device 100 according to an exemplary embodiment of the present disclosure.

In order to remove the calcium-reduced by-product of Nd₂Fe₁₄B obtained according to the method for preparing magnet powder according to the present disclosure (2000), the powder may be cleaned using the cleaning device 100 according to an exemplary embodiment of the present disclosure and the cleaning method 1100 according to an exemplary embodiment of the present disclosure.

According to the method for preparing magnet powder according to the present disclosure (2000), manufacturing costs for magnet powder may be reduced by applying a reduction-diffusion method that is a bottom-up approach using a metal oxide in comparison with a conventional metal melting method that is a top-down approach.

### Example

Hereinafter, the present disclosure will be described in more detail with reference to the following examples. However, the following examples are merely presented to exemplify the present disclosure, and the scope of the present disclosure is not limited thereto. This is because the scope of the present disclosure is determined by matters described in the claims and able to be reasonably inferred therefrom.

### Embodiments

A method for manufacturing magnet powder according to an exemplary embodiment of the present disclosure is as described below.

A magnet powder according to an exemplary embodiment of the present disclosure was prepared by dissolving 3.25 mmol (1.426 g) of neodymium (III) nitrate, 14 mmol (5.771 g) of iron (III) nitrate nonahydrate, and 2.5 mmol (0.155 g) of boric acid, together with 2.995 g of glycine, in distilled water to prepare a primary mixture.

The primary mixture was instantaneously reacted at a temperature of 300° C. to obtain a black oxide.

The obtained oxide was reacted in a box furnace under atmospheric conditions at a temperature of 700° C. for 3 hours to remove a residual organic material of the oxide.

Powder, from which the residual organic material of the oxide was removed, obtained after the reaction was terminated was reacted in a tube furnace in a 5% H₂/Ar atmosphere at a temperature of 800° C. for 2 hours to obtain a hydrogen-reduced oxide.

0.3 to 0.4 g of the hydrogen-reduced oxide and 0.2 to 0.3 g of calcium were uniformly mixed to obtain a secondary mixture. A pressure of 20 MPa was applied to the secondary mixture using a circular (¢ 20 mm) mold to obtain a coin-shaped model (pellets).

The pellets of the secondary mixture were subjected to calcium reduction-diffusion reaction in a tube furnace in an inert gas (Ar) atmosphere at a temperature of 850° C. for 3 hours.

After the reaction was terminated, a sample of the coin-shaped sample was pulverized using a mortar to prepare Nd₂Fe₁₄B powder.

Simultaneously, 0.42 g of CaO was obtained. In addition, in consideration that all of Ca was not reduced, obtaining of 0.3 g of Ca was also considered.

The cleaning solution and zeolite included in the cleaning material according to an exemplary embodiment of the present disclosure will be described as below.

The cleaning solution was prepared by mixing 0.8 to 3.2 g of NH₄NO₃ with 200 mL of methanol or by mixing 8 g of NH₄NO₃ and 1 L of methanol such that a molarity of the cleaning solution was from 0.05 to 0.2 M. Preferably, the molarity was 0.1 M.

In the case of cleaning CaO with the cleaning solution, 0.135 g of H₂O is generated from CaO via Reaction Schemes 1 and 2 below.

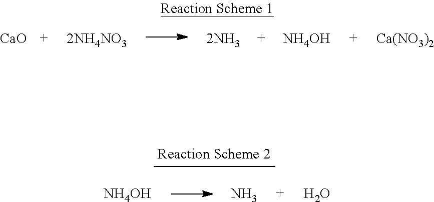

In the case of cleaning Ca with the cleaning solution, 0.015 g of H₂ was generated via Reaction Scheme 3 below.

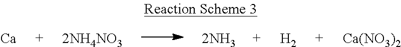

The generated H₂O and H₂ may cause side reactions during the cleaning process.

In an exemplary embodiment of the present disclosure, zeolite was included in the cleaning material to prevent effects of H₂O and H₂ generated during the cleaning process, H₂O dissolved in methanol, and H₂O in the air on the magnet powder.

Zeolite may absorb water by 22% of the weight of zeolite. Therefore, even 1 g of zeolite may sufficiently adsorb H₂O and H₂ generated during the cleaning process.

Accordingly, a large amount (5 g to 60 g) of zeolite was included in the cleaning material in the exemplary embodiment of the present disclosure in consideration of moisture in the air and in the methanol. Thereby, side reaction may be minimized while cleaning the magnet powder.

Hereinafter, examples of the present disclosure will be compared with comparative examples.
X-ray diffraction (XRD) was performed using a model ‘D/MAX-2500/PC, Rigaku with Cu Kα radiation 1.5406 Å)’. This was used to evaluate quantity of crystalline phase constituting a magnetic material. Hydrogenation of Nd₂Fe₁₄B powder particles may be determined by a degree of shifting to the left in a XRD pattern. The XRD shown in the drawings and tables represent an X-ray diffraction pattern and values of powder obtained by calcium reduction-diffusion at a temperature of 850° C.

VSM was performed using a model ‘VSM7410, Lakeshore, maximum field of 25 kOe’. This is used to evaluate magnetic properties of a magnetic material. Mₛ represents saturation magnetization value, Mᵣ represents remanent magnetization value, H_{ci} represents coercivity, and Mᵣ/Mₛ means a value obtained by dividing the remanent magnetization value by the saturation magnetization value. The coercivity was a value indicating a degree of difficulty in magnetic switching in a permanent magnet material as an important property of the permanent magnet. In general, in the case of cleaning the magnet powder, coercivity decreases and saturation magnetization value decreased due to calcium impurities. VSD values shown in the drawings and tables of the present disclosure correspond to values of powder obtained by calcium reduction-diffusion at a temperature of 850° C.

Inductively coupled plasma-atomic emission spectroscopy (ICP-AES) was performed using a model ‘SPECTRO ARCOS’. This was used to evaluate quantity of elements of the cleaning solution. That is, this indicates a concentration of a solution in the last cleaning operation. Based on the ICP values, concentrations of elements contained in a cleaning solution of the last cleaning operation may be obtained. A high concentration of Ca contained in the cleaning solution means efficient removal of Ca. Low concentrations of Nd and Fe mean efficient cleaning process of the magnet powder with low side reactions.
Field emission-scanning electron microscopy (FE-SEM), Energy-dispersive X-ray spectroscopy (EDS) was performed using a model ‘MIRA-3, Tescan, HV: 15.0 kV’. This was used for qualitative and quantitative analysis of elements on the surface of magnetic particles. Based on the SEM-EDS values, amounts of elements present on the surface of the magnet powder may be obtained. A low Ca at % (atomic percent) means that the magnet powder was efficiently performed so that a low amount of Ca exists on the surface.

Example 1 is compared with Comparative Example 1 below.

Unlike Comparative Example 1, the magnet powder was cleaned using the cleaning method 1100 with a cleaning material including zeolite in Example 1 according to the present disclosure.

Based thereon, effects of the cleaning method 1100 performed by using the cleaning material including zeolite may be confirmed.

For cleaning the magnet powder to remove by-products of the magnet powder according to Example 1, a cleaning solution was prepared by mixing 8.0 g of NH₄NO₃ with 1 L of methanol.

A process of adding 5 g to 60 g of zeolite and calcium-reduced powder to a 3-neck round-bottom flask and adding 200 mL of the cleaning solution thereto was performed for 20 minutes three times to five times. While the process was repeated three times to five times, zeolite and the cleaning solution were repeatedly replaced. In the last process, residual by-products such as Ca(NO₃)₂ were removed using the same amount of pure methanol.

After separating the magnet powder from zeolite using a permanent magnet, the cleaning was finished by drying the magnet powder in a vacuum oven (at a temperature of 65 to 90° C.) to obtain Nd₂Fe₁₄B powder particles.

For cleaning the magnet powder to remove by-products of the magnet powder according to Comparative Example 1, a cleaning solution was prepared by mixing 8.0 g of NH₄NO₃ with 1 L of methanol (hereinafter, 0.1 M NH₄NO₃/Methanol).

A process of adding calcium-reduced powder to a flask and adding 200 mL of the cleaning solution thereto was performed for 20 minutes three times to five times. In the last process, residual by-products such as Ca(NO₃)₂ were removed using the same amount of pure methanol.

Finally, the product was dried in a vacuum oven (at a temperature of 65 to 90° C.) to obtain Nd₂Fe₁₄B powder particles.

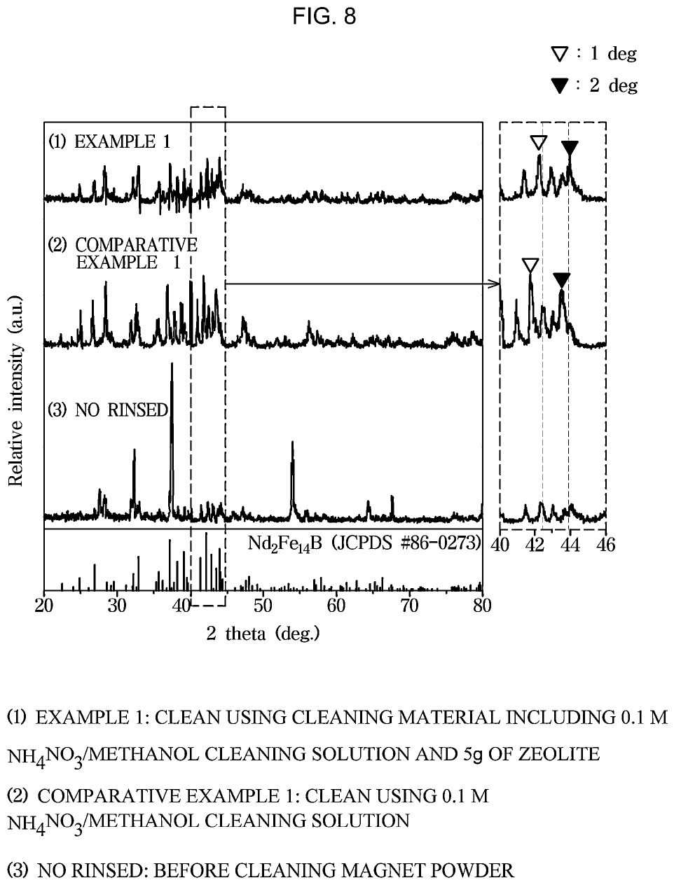

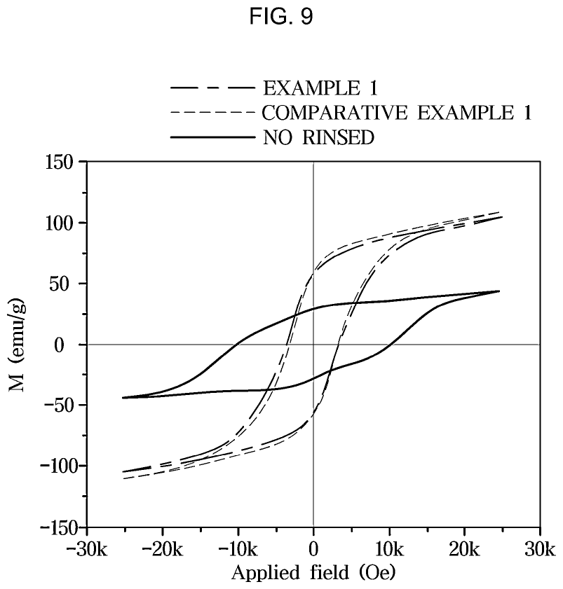

FIG. 8 is a graph illustrating XRD pattern analysis of Example 1 and Comparative Example 1. FIG. 9 is a VSM graph of Example 1 and Comparative Example 1.

In FIGS. 8 and 9, the ‘no rinsed’ was shown for comparison of the results between the product of Example 1 and no rinsed magnet powder. The ‘0.1 M NH₄NO₃/Methanol (only solution)’ according to Comparative Example 1 was prepared by cleaning the product only using the cleaning solution without using zeolite in the cleaning material for comparison with Example 1. The ‘zeolite with 0.1 M NH₄NO₃/Methanol’ according to Example 1 was prepared by cleaning the product using the cleaning material including zeolite.

Table 1 below shows values of FIG. 8.

TABLE 1

| | 1 (deg.) | Shift (Δ) | 2 (deg.) | Shift (Δ) |
|---|---|---|---|---|
| Example 1 | 42.24 | 0.06 | 43.98 | 0.06 |
| Comparative | 41.74 | 0.56 | 43.52 | 0.52 |
| Example 1 | | | | |
| No rinsed | 42.3 | — | 44.04 | — |

The XRD pattern of Example 1 is similar to that of the no rinsed magnet powder rather than that of Comparative Example 1.

In the case of Comparative Example 1, it may be confirmed that the XRD pattern was shifted more to the left due to more hydrogenation occurred compared to Example 1 because zeolite was not used and was not adsorbed thereonto. In addition, because more NdH₂ peaks were observed in Comparative Example 1 compared to Example 1, more side reactions occurred in Comparative Example 1.

Also, because less peaks related to calcium by-products such as Ca and CaO were observed in Example 1, selective removal of the calcium by-products was more efficiently performed compared to Comparative Example 1.

Based thereon, in the case of using the cleaning material including the cleaning solution together with zeolite, H₂O and H₂ generated during the cleaning process, H₂O dissolved in methanol, and H₂O in the air may be adsorbed to reduce hydrogenation so that the by-products may be removed while minimizing side reactions.

Table 2 below shows values of FIG. 9.

TABLE 2

| | Mₛ (emu/g) | Mᵣ (emu/g) | H_{ci} (kOe) | Mᵣ/Mₛ |
|---|---|---|---|---|
| Example 1 | 103.9 | 57.500 | 3.5 | 0.5536 |
| Comparative Example 1 | 109.1 | 56.447 | 3.3 | 0.5175 |
| No rinsed | 44.05 | 28.632 | 9.9 | 0.6500 |

In comparison of coercivity, the no rinsed magnet powder had a coercivity of 9.9 kOe, and the coercivity of Comparative Example 1 decreased to 3.3 kOe by 6.6 kOe and the coercivity of Example 1 decreased to 3.5 kOe by 6.4 kOe.

Based thereon, the coercivity of Example 1, in which the cleaning material including the cleaning solution and zeolite was used, less decreased than the coercivity of Comparative Example 1, in which only the cleaning solution was used.

Table 3 below shows ICP, SEM-EDS, and VSM values of Example 1 and Comparative Example 1.

TABLE 3

| | | | | Physical properties | | | | | | | |
|---|---|---|---|---|---|---|---|---|---|---|---|
| | | | | | | | SEM-EDS | | | VSM | |
| | Composition | | | ICP [ppm] | | | [atomic %] | | | Mₛ | H_{ci} |
| | 1 | 2 | 3 | Ca | Nd | Fe | Ca | Nd | Fe | [emu/g] | [kOe] |
| Example 1 | zeolite | 0.1M | — | 69.4 | 0.22 | 0.19 | 0.67 | 20.65 | 78.65 | 103.9 | 3.5 |
| | | NH₄NO₃/ | | | | | | | | | |
| | | Methanol | | | | | | | | | |
| Comparative | — | 0.1M | — | 1.84 | 0.4 | 4.71 | 0.73 | 21.32 | 77.95 | 109.1 | 3.3 |
| Example 1 | | NH₄NO₃/ | | | | | | | | | |
| | | Methanol | | | | | | | | | |
| No rinsed | — | — | — | — | — | — | 64.04 | 7.34 | 28.62 | 44.05 | 9.9 |

Upon comparison of ICP, the Ca concentration of Comparative Example was 1.84 ppm and that of Example 1 was 69.4 ppm indicating that the Ca concentration of the cleaning solution of the last cleaning process of Example 1 was greater. Also, the Nd concentration was 0.4 ppm and the Fe concentration was 4.71 ppm in Comparative Example 1 which were greater than the Nd concentration (0.22 ppm) and the Fe concentration (0.19 ppm) of Example 1 in the cleaning solution of the last cleaning process.

Upon comparison of SEM-EDS, the surface Ca at % was 64.04 at % in the no rinsed magnet powder, 0.73 at % in Comparative Example 1, and 0.67 at % in Example 2. Thus, the Ca at % of the surface of the magnet powder of Comparative Example 1 after cleaning was greater than that of Example 1.

Based thereon, cleaning was more efficiently performed to have a low Ca at % on the surface of the magnet powder after cleaning in the case of using the cleaning material including the cleaning solution and zeolite, compared to the case of only using the cleaning solution. In addition, side reaction decreased while cleaning the magnet powder.

As a result, side reactions may be prevented by reducing hydrogenation while cleaning the magnet powder, by-products may be selectively removed, and damage to magnetic properties of the magnetic powder may be minimized in the case of performing the cleaning method 1100 for cleaning the magnet powder using the cleaning material including the cleaning solution and zeolite.

Example 2 is compared with Comparative Example 2 below.

Unlike Comparative Example 2, the magnet powder was cleaned using the cleaning device 100 according to the present disclosure including the vacuum manifold 120 for injecting an inert gas and vacuum drying in Example 2.

Based thereon, effects of the cleaning device 100 on maintaining an inert environment throughout a cleaning process may be confirmed by using the vacuum manifold 120.

For cleaning the magnet powder to remove by-products of the magnet powder according to Example 2 of the present disclosure, a cleaning solution was prepared by mixing 0.8 to 3.2 g of NH₄NO₃ and 200 mL of methanol (hereinafter, 0.05 to 0.2 M NH₄NO₃/Methanol, an optimal concentration thereof is 0.1 M in the present disclosure).

A process of adding 5 g to 60 g of zeolite and calcium-reduced powder to a 3-neck round-bottom flask and adding 200 mL of the cleaning solution thereto was performed for 20 minutes three times to five times.

While the process was repeated three times to five times, zeolite and the cleaning solution were repeatedly replaced.

In this regard, a high-purity inert gas was injected using the vacuum manifold 120. A speed of the magnetic stirrer 170 applied during the cleaning was from 100 to 1000 rpm. A syringe was used to discard the used cleaning solution and adding new cleaning solution. In the last process, residual by-products such as Ca(NO₃)₂ were removed using the same amount of pure methanol.

Finally, the resultant was dried in a vacuum by the vacuum pump 140 using the vacuum manifold 120 to obtain Nd₂Fe₁₄B powder particles.

For cleaning the magnet powder to remove by-products of the magnet powder according to Comparative Example 2, a cleaning solution was prepared by mixing 8.0 g of NH₄NO₃ and 1 L of methanol (hereinafter, 0.1 M NH₄NO₃/Methanol).

A process of adding 5 g to 60 g of zeolite and calcium-reduced powder to a 3-neck round-bottom flask 110, adding 200 mL of the cleaning solution thereto, and injecting a high-purity inert gas (Ar or N₂) was performed for 20 minutes three times to five times.

While the process was repeated three times to five times, zeolite and the cleaning solution were repeatedly replaced.

In the last process, residual by-products such as Ca(NO₃)₂ were removed using the same amount of pure methanol.

Finally, the cleaning was finished by vacuum drying the product in a vacuum oven (65 to 90° C.) to obtain Nd₂Fe₁₄B powder particles.

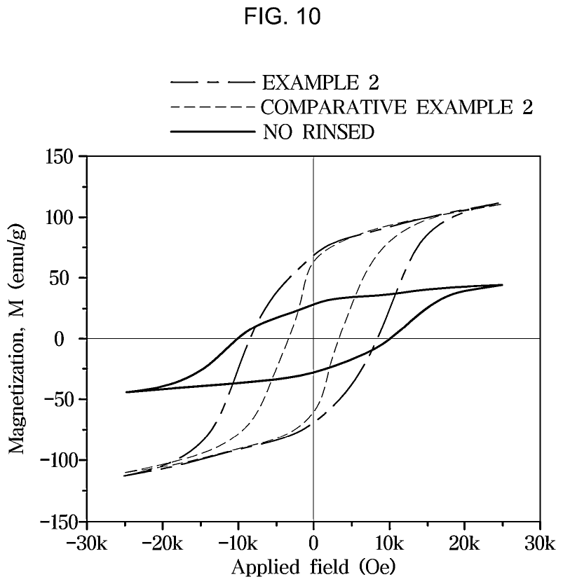

FIG. 10 shows a VSM graph of Example 2 and Comparative Example 2.

In FIG. 10, the ‘no rinsed’ was shown for comparison of the results between the product of Example 2 and no rinsed magnet powder. The ‘5 g zeolite+gas bubbling with 0.1 M NH₄NO₃/Methanol’ according to Comparative Example 2 was prepared by injecting the inert gas without using the vacuum manifold for comparison with Example 2. The ‘zeolite with 0.1 M NH₄NO₃/Methanol in vacuum manifold’ according to Example 2 was prepared by using the cleaning device by which an inert environment was maintained throughout the cleaning process using the vacuum manifold.

Table 4 below shows values of FIG. 10.

TABLE 4

| | Mₛ (emu/g) | Mr (emu/g) | H_{ci} (kOe) | Mᵣ/Mₛ |
|---|---|---|---|---|
| Example 2 | 112.0 | 69.23 | 8.4 | 0.6182 |
| Comparative | 109.7 | 56.447 | 3.4 | 0.5175 |
| Example 2 | | | | |
| No rinsed | 44.05 | 28.632 | 9.9 | 0.6500 |

In comparison of coercivity, the no rinsed magnet powder had a coercivity of 9.9 kOe, and the coercivity of Comparative Example 2 decreased to 3.4 kOe by 6.5 kOe and the coercivity of Example 2 decreased to 8.4 kOe by 1.5 kOe.

Also, in comparison of saturation magnetization, the no rinsed magnet powder had a saturation magnetization of 44.04 emu/g. While the saturation magnetization of Comparative Example 2 increased to 109.7 emu/g by about 2.49 times, the saturation magnetization of Example 2 increased to 112.0 emu/g by about 2.54 times, and thus it was confirmed the saturation magnetization value increased more in Example 2.

Based thereon, in the case of Example 2 using the cleaning device 100 for injecting the inert gas using the vacuum manifold 120, damage to the magnet powder was minimized due to a lower coercivity and the saturation magnetization significantly increased compared to those of Comparative Example 2 in which cleaning was performed by injecting the inert gas without using the vacuum manifold.

Table 5 below shows ICP, SEM-EDS, and VSM values of Example 2 and Comparative Example 2.

TABLE 5

| | | | | Physical properties | | | | | | | |
|---|---|---|---|---|---|---|---|---|---|---|---|
| | | | | | | | SEM-EDS | | | VSM | |
| | Composition | | | ICP [ppm] | | | [atomic %] | | | Mₛ | H_{ci} |
| | 1 | 2 | 3 | Ca | Nd | Fe | Ca | Nd | Fe | [emu/g] | [kOe] |
| Example 2 | zeolite | 0.1M | Inert | 70.23 | 0.021 | 0.087 | 0.23 | 17.5 | 81.65 | 112.0 | 8.4 |
| | | NH₄NO₃/ | environment | | | | | | | | |
| | | Methanol | using | | | | | | | | |
| | | | Schlenk line | | | | | | | | |
| | | | (injecting | | | | | | | | |
| | | | inert gas) | | | | | | | | |
| Comparative | zeolite | 0.1M | Injecting | 67.12 | 0.16 | 0.13 | 0.30 | 18.67 | 81.03 | 109.7 | 3.4 |
| Example 2 | | NH₄NO₃/ | inert gas | | | | | | | | |
| | | Methanol | without | | | | | | | | |
| | | | using | | | | | | | | |
| | | | Schlenk line | | | | | | | | |
| No rinsed | — | — | — | — | — | — | 64.04 | 7.34 | 28.62 | 44.05 | 9.9 |

Upon comparison of ICP, the Ca concentration of Comparative Example 2 was 67.12 ppm and the Ca concentration of Example 2 was 70.23 ppm, indicating that the Ca concentration of the cleaning solution in the last cleaning process of Example 2 was greater than that of Comparative Example 2. Also, the Nd concentration was 0.16 ppm and the Fe concentration was 0.13 ppm in Comparative Example 2 which were greater than the Nd concentration (0.021 ppm) and the Fe concentration (0.087 ppm) of Example 2 in the cleaning solution in the last cleaning process.

Upon comparison of SEM-EDS, the surface Ca at % was 64.04 at % in the no rinsed magnet powder, 0.30 at % in Comparative Example 2, and 0.23 at % in Example 2. Thus, the Ca at % of the last cleaning process of Comparative Example 2 after cleaning was greater than that of Example 2.

Based thereon, cleaning was more efficiently performed to have a low Ca at % on the surface of the magnet powder after cleaning in the case of maintaining the inert environment throughout the cleaning process by injecting the inert gas using the vacuum manifold 120, compared to the case of injecting the inert gas without using the vacuum manifold 120. Also, less side reaction occurred while the magnet powder was cleaned.

As a result, by-products may be selectively removed, damage to magnetic properties of the magnetic powder may be minimized, and purity of the magnet powder may be improved in the case where the magnet powder was cleaned using the cleaning device 100 capable of maintaining the inert environment throughout the cleaning process by injecting the inert gas using the vacuum manifold 120.

Example 2 is compared with Comparative Example 1 below.

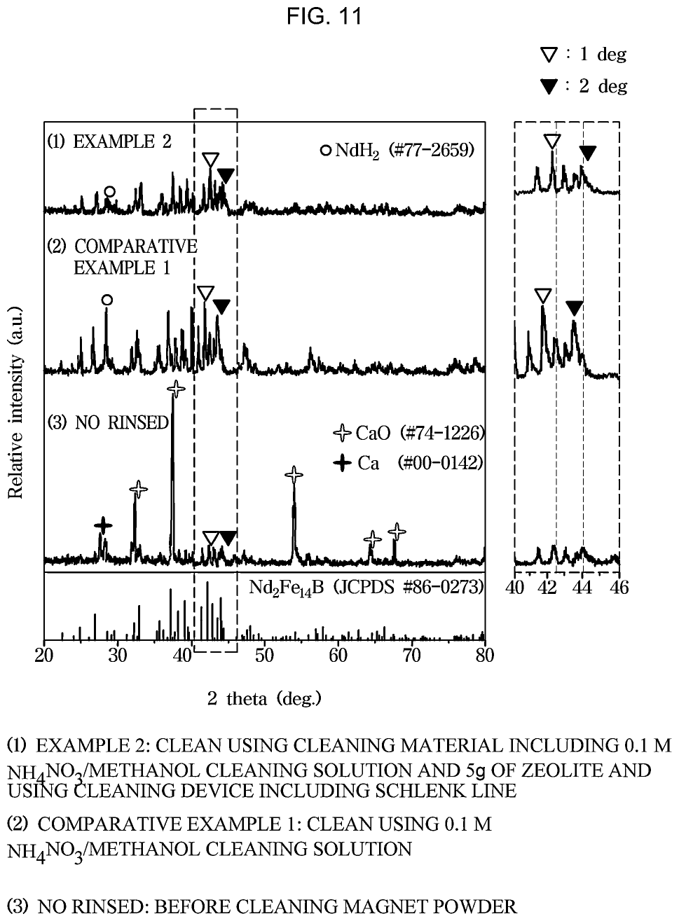

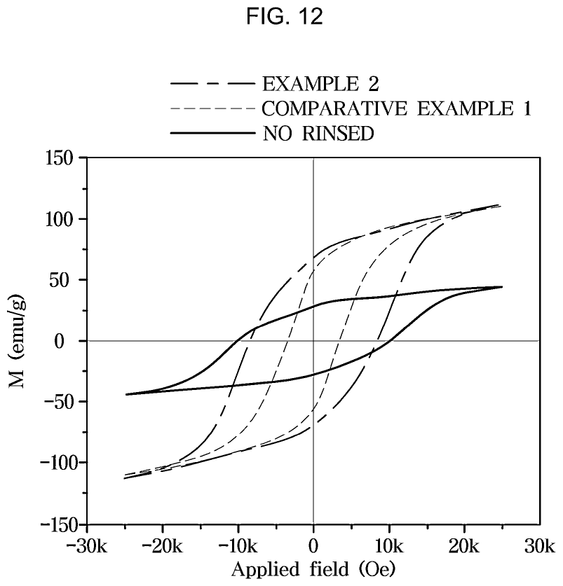

FIG. 11 is a graph illustrating XRD pattern analysis of Example 2 and Comparative Example 1. FIG. 12 is a VSM graph of Example 2 and Comparative Example 1.

Based thereon, cleaning effects of the cleaning method 1100 using the cleaning material including zeolite and using the cleaning device 100, by which the inert environment was maintained throughout the cleaning process using the vacuum manifold 120, may be obtained.

Table 6 below shows values of FIG. 11.

TABLE 6

| | 1 (deg.) | Shift (Δ) | 2 (deg.) | Shift (Δ) |
|---|---|---|---|---|
| Example 2 | 42.28 | 0.02 | 43.98 | 0.06 |
| Comparative | 41.74 | 0.56 | 43.52 | 0.52 |
| Example 1 | | | | |
| No rinsed | 42.3 | — | 44.04 | — |

In the case of Comparative Example 1 without using zeolite, the XRD pattern was more shifted to the left compared to Example 2 using zeolite because hydrogenation excessively occurred since water was not adsorbed by zeolite. In addition, more NdH₂ peaks were observed in Comparative Example 1 compared to Example 2, and thus more side reactions occurred in Comparative Example 1.

Also, because peaks related to calcium by-products such as Ca and CaO were not observed in the case of Example 2, selective removal of the calcium by-products was more efficiently performed.

Based thereon, in the case of using the cleaning material including the cleaning solution together with zeolite, H₂O and H₂ generated during the cleaning process, H₂O dissolved in methanol, and H₂O in the air may be adsorbed to reduce hydrogenation so that the by-products may be removed while minimizing side reactions.

Table 7 below shows values of FIG. 12.

TABLE 7

| | Mₛ (emu/g) | Mᵣ (emu/g) | H_{ci} (kOe) | Mᵣ/Mₛ |
|---|---|---|---|---|
| Example 2 | 112.0 | 69.230 | 8.4 | 0.6182 |
| Comparative Example | 109.1 | 56.447 | 3.3 | 0.5175 |
| 1 | | | | |
| No rinsed | 44.05 | 28.632 | 9.9 | 0.6500 |

In comparison of coercivity, the no rinsed magnet powder had a coercivity of 9.9 kOe, and the coercivity of Comparative Example 1 decreased to 3.3 kOe by 6.6 kOe and the coercivity of Example 2 decreased to 8.4 kOe by 1.5 kOe.

Also, in comparison of saturation magnetization, the no rinsed magnet powder had a saturation magnetization of 44.04 emu/g. While the saturation magnetization of Comparative Example 1 increased to 109.1 emu/g by about 2.47 times, the saturation magnetization of Example 2 increased to 112.0 emu/g by about 2.54 times, and thus it was confirmed the saturation magnetization value increased more in Example 2.

Based thereon, in the case of Example 2 using the cleaning material including the cleaning solution together with zeolite and using the cleaning device 100 for injecting the inert gas using the vacuum manifold 120, the coercivity decreased less and the saturation magnetization increased more compared to Comparative Example 1 in which the cleaning was performed only using the cleaning solution without injecting the inert gas.

Table 8 below shows ICP, SEM-EDS, and VSM values of Example 2 and Comparative Example 1.

TABLE 8

| | | | | Physical properties | | | | | | | |
|---|---|---|---|---|---|---|---|---|---|---|---|
| | | | | | | | SEM-EDS | | | VSM | |
| | Composition | | | ICP [ppm] | | | [atomic %] | | | Mₛ | H_{ci} |
| | 1 | 2 | 3 | Ca | Nd | Fe | Ca | Nd | Fe | [emu/g] | [kOe] |
| Example 2 | zeolite | 0.1M | Inert | 70.23 | 0.021 | 0.087 | 0.23 | 17.5 | 81.65 | 112.0 | 8.4 |
| | | NH₄NO₃/ | environment | | | | | | | | |
| | | Methanol | using | | | | | | | | |
| | | | Schlenk line | | | | | | | | |
| | | | (injecting | | | | | | | | |
| | | | inert gas) | | | | | | | | |
| Comparative | — | 0.1M | — | 1.84 | 0.4 | 4.71 | 0.73 | 21.32 | 77.95 | 109.1 | 3.3 |
| Example 1 | | NH₄NO₃/ | | | | | | | | | |
| | | Methanol | | | | | | | | | |
| No rinsed | — | — | — | — | — | — | 64.04 | 7.34 | 28.62 | 44.05 | 9.9 |

Upon comparison of ICP, the Ca concentration of Comparative Example 1 was 1.84 ppm and the Ca concentration of Example 2 was 70.23 ppm, indicating that the Ca concentration of the cleaning solution in the last cleaning process of Example 2 was greater than that of Comparative Example 1. Also, the Nd concentration was 0.4 ppm and the Fe concentration was 4.71 ppm in Comparative Example 1 which were higher than the Nd concentration (0.021 ppm) and the Fe concentration (0.087 ppm) of Example 2 in the cleaning solution in the last cleaning process.

Upon comparison of SEM-EDS, the surface Ca at % was 64.04 at % in the no rinsed magnet powder, 0.73 at % in Comparative Example 1, and 0.23 at % in Example 2. Thus, the surface atomic content of Ca (at %) of the magnet powder of Comparative Example 1 after cleaning was greater than that of Example 2. In consideration of an error range of the amount present on the surface of the magnet powder particles after cleaning, the amount of by-product Ca is about 0 when the cleaning is performed according to Example 2.

Based thereon, the cleaning is more efficiently performed to have a low surface atomic content of Ca (at %) after cleaning in the case where the cleaning material includes the cleaning solution and zeolite and the inert environment is maintained throughout the cleaning process by injecting the inert gas using the vacuum manifold 120, compared to the case of cleaning only using the cleaning solution without injecting the inert gas. In addition, less side reaction occurred while cleaning the magnet powder.

As a result, when the magnet powder is cleaned by the cleaning method 1100 using the cleaning material including the cleaning solution together with zeolite and using the cleaning device 100 for maintaining an inert environment throughout a cleaning process by injecting an inert gas using the vacuum manifold 120, side reaction of the magnet powder may be minimized due to less occurrence of hydrogenation, by-products may be selectively removed, damage to magnetic properties of the magnet powder may be minimized, and purity of the magnet powder may be improved.

As is apparent from the above, according to the cleaning device according to various exemplary embodiments of the present disclosure, by maintaining an inert environment throughout the cleaning process, damage to magnet powder caused by selective wet cleaning of a calcium compound may be minimized, reduction in coercivity may be minimized, and high-purity, high-performance magnetic material powder may be obtained.

Also, according to the cleaning method according to various exemplary embodiments of the present disclosure, by using a cleaning material including zeolite to adsorb H₂O and H₂ during a cleaning process, side reaction of magnet powder may be minimized.

According to the method for manufacturing magnet powder according to various exemplary embodiments of the present disclosure, manufacturing costs of a permanent magnet may be reduced by applying a reduction-diffusion method that is a bottom-up approach using a low-priced metal oxide, compared to a conventional metal melting method that is a top-down approach.

While the present disclosure has been particularly shown and described with reference to exemplary embodiments thereof, it will be understood by one of ordinary skill in the art that various changes in form and details may be made therein without departing from the spirit and scope of the present disclosure as defined by the following claims.

1-19. (canceled)

20. A method for cleaning a magnet powder, comprising:
loading a magnet powder, a cleaning solution, and zeolite into a flask;
injecting an inert gas into the flask; and
drying the magnet powder and the zeolite by applying a vacuum.

21. The method according to claim 20, further comprising:
manufacturing the magnet powder loaded into the flask; and
preparing the cleaning solution comprising an ammonium salt and methanol.

22. The method according to claim 21, wherein the magnet powder comprises Nd2Fe14B powder manufactured by a calcium reduction-diffusion method.

23. The method according to claim 21, wherein the ammonium salt comprises NH4NO3, and a molarity of NH4NO3 and methanol of the cleaning solution ranges from about 0.05 M to about 0.2 M.

24. The method according to claim 20, wherein steps of the loading the magnet powder, injecting the inert gas, and the drying the magnet powder and the zeolite are repeated three times to five times.

25. The method according to claim 20, wherein the method comprises using a cleaning device,
wherein the cleaning device comprises a vacuum manifold provided to maintain the magnet powder, the cleaning solution, and the zeolite contained in the flask in an inert state.

26. The method according to claim 25, wherein the cleaning device further comprises:
a gas inlet provided to inject an inert gas;
a vacuum pump provided to remove gas contained in the flask; and
a cold trap provided to condense the gas removed from the flask.

27. The method according to claim 26, wherein the cleaning device further comprises an oil bubbler provided to discharge the inert gas.

28. A method for manufacturing a magnet powder, the method comprising:
preparing a primary mixture comprising neodymium (III) nitrate, boric acid, and iron (III) nitrate nonahydrate;
preparing an oxide by heat-treating the primary mixture at a first temperature;
removing a residual organic material of the oxide by heat-treating the oxide at a second temperature;
preparing a hydrogen-reduced oxide by heat-treating the oxide, from which the residual organic material is removed, with hydrogen at a third temperature with hydrogen;
preparing a secondary mixture comprising the hydrogen-reduced oxide and calcium;
obtaining a product by heat-treating the secondary mixture at a fourth temperature for reduction-diffusion reaction; and
obtaining Nd2Fe14B powder by pulverizing the product.

29. The method according to claim 28, wherein the heat-treating the primary mixture is performed at the first temperature from about 200 to 400° C.

30. The method according to claim 28, wherein the heat-treating the oxide is performed at the second temperature of about 600 to 800° C. for about 150 to 200 minutes.

31. The method according to claim 28, wherein the heat-treating the oxide, from which the residual organic material is removed, with hydrogen is performed at the third temperature of about 700 to 900° C. for about 100 to 150 minutes.

32. The method according to claim 28, wherein the heat-treating the secondary mixture is performed at the fourth temperature of about 750 to 900° C. for about 150 to 200 minutes.
